(19) United States
(12) Patent Application Publication
(10) Pub. No.: US 2009/0245185 A1
(43) Pub. Date: Oct. 1, 2009

(54) Method of Scheduling Groups of Mobile Users

(76) Inventors: Thomas Malcolm Chapman, Southampton (GB); Jörn Krause, Berlin (DE); Ingo Viering, München (DE)

Correspondence Address: STAAS & HALSEY LLP, SUITE 700, 1201 NEW YORK AVENUE, N.W., WASHINGTON, DC, 20005, US

(21) Appl. No.: 12/087,921

(22) PCT Filed: Dec. 8, 2006
(86) PCT No.: PCT/GB2006/050442

§ 371 Date: Dec. 16, 2008

(30) Foreign Application Priority Data
Jan. 17, 2006 (GB) 0600870.0
May 26, 2006 (GB) 0610402.0

(51) Int. Cl. H04W 72/04

(52) U.S. Cl. 370/329

(57) ABSTRACT

A method of scheduling groups of mobile users includes setting a group identifier for each mobile user and scheduling physical layer resources at a base station for those users requiring resources. The physical layer resources are divided into sub-resources shared between mobile users having the same group identifier and provide an indication with the physical layer resources of the occurrence and position within the physical layer resources of the sub-resources allocated to each mobile user in the group.

### CROSS REFERENCE TO RELATED APPLICATIONS

This application is based on and hereby claims priority to Great Britain Application No. 0600870.0 filed on Jan. 17, 2006, Great Britain 0610402.0, filed May 26, 2006, and PCT Application No. PCT/GB2006/050442, filed on Dec. 8, 2006, the contents of which are hereby incorporated by reference.

### SUMMARY OF THE INVENTION

This invention relates to a method of scheduling groups of mobile users. A method of scheduling groups of mobile users comprises setting a group identifier for each mobile user; scheduling physical layer resources at a base station, for those users requiring resources; wherein the physical layer resources are divided into sub-resources shared between mobile users having the same group identifier; and providing an indication with the physical layer resources, of the occurrence and position within the physical layer resources of the sub-resources allocated to each mobile user in the group.

Preferably, the physical layer resources comprise a protocol data unit (PDU) and the sub-resources comprise sub-PDU's.

Preferably, the indication is provided in a higher layer header. Preferably, the header is a medium access control header (MAC). Preferably, the position of sub-resources for each user, within the physical layer resources, is pre-allocated; and the indicator identifies whether or not sub-resources for that user are provided in a specific transmission.

Preferably, the physical layer resources comprise a particular frequency band and the sub-resources comprise frequency chunks within the band. In one embodiment, the group comprises all mobile users scheduled by the base station.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1A to 1D illustrate a system for carrying out the method proposed by the inventors.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The proposed method addresses the problem of multiplexing very low rate data to users of a fast scheduled packed mobile radio system, where the amount of data to be transmitted to each user is much smaller than the smallest resource than can be allocated by the scheduler. The particular radio system under consideration is orthogonal frequency division multiple access (OFDMA) based, but the method can be applied to other access schemes, such as code division multiple access (CDMA).

In a fast scheduled packet radio system, a basestation scheduler allocates downlink and uplink physical resources to users in a dynamic fashion. In an OFDMA system, these resources are time/frequency chunks; whereas in a CDMA system the resources might be parts of a code tree. Users decode resource if indicated to do so, but otherwise do not listen to resources allocated for other users.

For maximum scheduling efficiency, the minimum size of resource that can be allocated to a user should be kept as small as possible, in order that low data rate users can be served efficiently. However as the size of allocated resources becomes smaller, the amount of signaling overhead required to support the scheduling increases.

Typically, a specific signaling channel will be used for indicating to a user which physical downlink resources the user should listen to. In wideband CDMA (WCDMA) systems, an example of such signaling is the high speed shared control channel (HS-SCCH). The signaling generally contains an indication of the identity of the intended recipient and the location of downlink (DL) resources on which data should be received.

Consider in particular an OFDMA system in which time and frequency chunks are allocated to users. In the context of 3<rd> generation partnership project (3GPP) systems, a typical downlink minimum chunk size might be 300 to 1200 bits, dependent on the type of modulation used. A typical uplink chunk size might be as large as 750 to 3000 bits. Certain types of transmission, for example speech frames, gaming information, control information, or transmission control protocol/internet protocol (TCP/IP) acknowledgements (ACKs) however might generate significantly fewer bits than this and yet be time critical, thus preventing the accumulation of data for a UE before transmitting. Utilizing the minimum resource allocation in such cases, typically 25 tones by 6 symbols for OFDMA, leads to a wastage of resources.

To avoid invoking a large amount of signaling overhead, reasonably large resource allocation chunks are preferable. Furthermore, for signaling efficiency it is preferable that the basic scheduling signaling channel has a restricted amount of formats. This proposed method reconciles these aspects with the need to cope with low data rate users.

The inventors propose that in addition to individual identities, scheduling of physical resources can be made with identities that relate to groups of terminals or in the extreme case, all of the terminals that are served by the scheduler. If a downlink physical resource allocation is made using such an identity, each terminal checks whether it is able to decode the indicated resources. Each terminal that can do so decodes. The “scheduling” might be applied for a single time instant and PDU or at regular intervals over a longer time duration.

The transmitted PDU is made up of multiple sub-PDUs, each of which is intended for a different terminal. The identity of the terminal for which each sub-PDU is intended is indicated using a MAC, or similar higher layer, header. Such a scheme may only be applicable for the downlink.

The gain achieved using the proposed method depends on the size of the MAC header that indicates which sub-PDUs are for which users. The size of the MAC header might be reduced by, for example using a predefined ordering of users together with a single bit indicator for each user whether that user does or does not have data.

Alternatively, a known sub-resource partition within the scheduled resource for the group of users indicated to decode the resource could be allocated in advance; for example in an OFDMA system a subset of time/frequency tones. In this case, no joint coding or higher layer header would be necessary and potentially different modulation formats could be used for different terminals. Such a scheme can also be applied in the uplink as well as in the downlink.

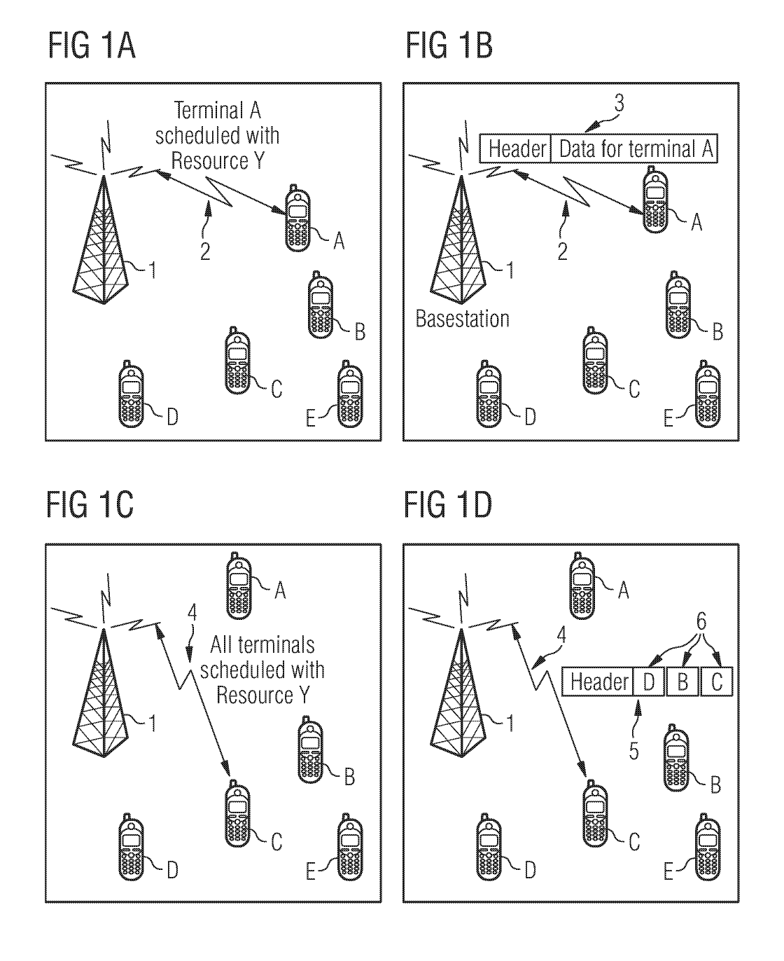

The system is illustrated in FIG. 1. In FIG. 1A, a basestation 1 which communicates with terminals A to E sends 2 a scheduling allocation of resource Y intended for terminal A. From FIG. 1B, it can be seen that only terminal A decodes a protocol data unit (PDU) 3 comprising a header and data for terminal A. FIG. 1C shows how the scheduler then makes a resource allocation 4 with an identity that is recognized by all terminals A, B, C, D and E and FIG. 1D shows the PDU 5 contains three sub-PDUs 6 for terminals D, B and C. A MAC header indicates which sub-PDU is intended for which terminal. The method combines fast scheduling of physical resources by the base station with the added aspect of allowing for groups of terminals to be scheduled the same physical resource simultaneously and uses a higher layer header in transmitted PDUs to allocate sub-sections of the PDU to different terminals at MAC or higher layers, or using a pre-defined partitioning of the resources between the terminals in the group. The physical resources that are scheduled are shared; i.e. basestations only decode the resources if indicated to, on a transmit time interval (TTI) basis. Which basestation decodes depends upon radio conditions and which TTI it is. The advantages of the method include a better use of resources, by using scheduling units to transmit to multiple users, rather than leaving sections of the chunks empty as would be the case where a chunk is allocated to only one user and the user does not have sufficient data to fill the chunk and the feature of an increase in coding gain by coding resources for multiple users together.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. (canceled)

2-7. (canceled)

8. A method of scheduling groups of mobile users, the method comprising:
setting a group identifier for each mobile user;
scheduling, at a base station, physical layer resources intended for the mobile users for those mobile users requiring resources;
dividing the physical layer resources into sub-resources, each sub-resource being shared between mobile users having the same group identifier; and
providing an indication with the physical layer resources of an occurrence and a position within the physical layer resources of the sub-resources allocated to each mobile user in the group.

9. A method according to claim 8, wherein the physical layer resources comprise a protocol data unit (PDU) and the -sub-resources each comprise a sub-PDU.

10. A method according to claim 8, wherein the indication is provided in a higher layer header. cm 11. A method according to claim 10, wherein the header is a medium access control header (MAC).

12. A method according to claim 10, wherein the position of sub-resources for each user, within the physical layer resources, is pre-allocated and the indicator identifies whether or not sub-resources for that user are provided in a specific transmission

13. A method according to claim 10, wherein the physical layer resources comprise a particular frequency band and the sub-resources comprise frequency chunks within the particular frequency band.

14. A method according to claim 10, wherein the group comprises all mobile users scheduled by the base station.

15. A method according to claim 9, wherein the indication is provided in a higher layer header.

16. A method according to claim 15, wherein the header is a medium access control header (MAC).

17. A method according to claim 16, wherein the position of sub-resources for each user, within the physical layer resources, is pre-allocated and the indicator identifies whether or not sub-resources for that user are provided in a specific transmission

18. A method according to claim 17, wherein the physical layer resources comprise a particular frequency band and the sub-resources comprise frequency chunks within the particular frequency band.

19. A method according to claim 18, wherein the group comprises all mobile users scheduled by the base station.
